(19) United States
(12) Patent Application Publication
(10) Pub. No.: US 2012/0096551 A1
(43) Pub. Date: Apr. 19, 2012

(54) INTRUSION DETECTING SYSTEM AND METHOD FOR ESTABLISHING CLASSIFYING RULES THEREOF

(75) Inventors: Hahn-Ming Lee, Taipei County (TW); Jerome Yeh, Taipei City (TW); Wei-Yi Yu, Taipei City (TW)

(73) Assignee: National Taiwan University of Science and Technology, Taipei (TW)

(21) Appl. No.: 13/107,956

(22) Filed: May 15, 2011

(30) Foreign Application Priority Data
Oct. 13, 2010 (TW) 99134925

(51) Int. Cl. G06F 21/00; G06F 15/18

(52) U.S. Cl. 726/23; 706/12

(57) ABSTRACT

A method for establishing classifying rules of an intrusion detecting system is provided with the following steps. First, at least one decision tree is provided. Internal nodes of the decision tree respectively represent an attribute judgment condition, and leaf nodes respectively represent an attack event or non-attack event. Next, a plurality of attribute data of at least one new attack event is received. Then, a tree structure of the decision tree is adjusted according to the attribute data. Afterwards, at least one attack rule or at least one non-attack rule is outputted according to the adjusted decision tree. Further, the intrusion detection system is also provided.

### CROSS-REFERENCE TO RELATED APPLICATION

This application claims the priority benefit of Taiwan application serial no. 99134925, filed on Oct. 13, 2010. The entirety of the above-mentioned patent application is hereby incorporated by reference herein and made a part of specification.

### BACKGROUND

1. Field of the Invention

The invention relates to a method for processing a network event and a related system. Particularly, the invention relates to a method for detecting a network intrusion event and a related system.

2. Description of Related Art

In today's information age, computers all over the world can be connected through the Internet, and enterprises or individuals generally use the Internet to transmit or access data. However, with popularity of the Internet, network attacks are rapidly increased, so that network security gradually draws attention. In a well-known network security mechanism, an intrusion detection system (IDS) plays an important role. The IDS is mainly used to surveille network or system events, and classifies the events into attack events or non-attack events according to pre-established rules. When an attack event is surveilled, besides sending a warning message to a network administrator, the system may also take a necessary measure to deal with the attack event, such as block a source Internet protocol (IP). Therefore, an excellent IDS can effectively enhance security of the network system.

Generally, a conventional IDS can establish classifying rules according to a batch offline learning method. However, when a new type of attack event is encountered, re-batch offline learning is required. Now, the IDS has to be offline and stops detecting, and the new type of attack event has to be added to original sample events, and then all of the events are relearned, and a whole rule database is re-established.

### SUMMARY OF THE INVENTION

The invention is directed to an intrusion detecting system and a method for establishing classifying rules thereof, by which the classifying rules for detecting intrusion events can be adjusted in real-time.

The invention provides a method for establishing classifying rules of an intrusion detecting system, which includes the following steps. First, at least one decision tree is provided. Internal nodes of the decision tree respectively represent an attribute judgment condition, and leaf nodes of the decision tree respectively represent an attack event or a non-attack event. Next, a plurality of attribute data of at least one new attack event is received. Then, a tree structure of the decision tree is adjusted according to the attribute data. Afterwards, at least one attack rule or at least one non-attack rule is outputted according to the adjusted decision tree.

In an embodiment of the invention, the step of adjusting the tree structure of the decision tree includes adjusting the tree structure of the decision tree according to an incremental tree induction method.

In an embodiment of the invention, before the step of adjusting the tree structure of the decision tree, the method for establishing classifying rules of the intrusion detecting system further includes normalizing the attribute data into a plurality of numerical data, wherein the numerical data are greater than or equal to 0 and are smaller than or equal to 1.

In an embodiment of the invention, before the step of adjusting the tree structure of the decision tree, the method for establishing classifying rules of the intrusion detecting system further includes finding the decision tree corresponding to the new attack event according to a clustering algorithm, so as to adjust the decision tree corresponding to the new attack event.

In an embodiment of the invention, before the step of adjusting the tree structure of the decision tree, the method for establishing classifying rules of the intrusion detecting system further includes selecting at least one significant attribute data from the attribute data according to a significant attribute list, so as to execute the clustering algorithm according to the significant attribute data.

In an embodiment of the invention, the step of providing the decision tree includes learning a plurality of training events in batch and online real-time to establish the decision tree.

The invention provides an intrusion detecting system including a decision tree module, a preprocessing module, a clustering module, an adjustment module, a rule output module and an attack rule database. The decision tree module is used for storing at least one decision tree. Internal nodes of the decision tree respectively represent an attribute judgment condition, and leaf nodes of the decision tree respectively represent an attack event or a non-attack event. The preprocessing module is used for receiving a plurality of attribute data of at least one new attack event. The clustering module is used for clustering similar attribute data in a same group. The adjustment module is used for adjusting a tree structure of the decision tree according to the attribute data. The rule output module is used for outputting at least one attack rule or at least one non-attack rule according to the adjusted decision tree. The attack rule database is used for storing the attack rule or the non-attack rule.

In an embodiment of the invention, the intrusion detecting system further includes a clustering module. The clustering module finds the decision tree corresponding to the new attack event according to a clustering algorithm, so as to adjust the decision tree corresponding to the new attack event.

In an embodiment of the invention, the intrusion detecting system further includes a significant attribute list module for storing a significant attribute list. The clustering module selects at least one significant attribute data from the attribute data according to the significant attribute list, so as to execute the clustering algorithm according to the significant attribute data.

In an embodiment of the invention, the intrusion detecting system further includes a warning message generating module and a warning message database. The warning message generating module is used for sending a warning message according to the attack rule database when being under attack. The warning message database is used for storing the warning message.

According to the above descriptions, the tree structure of the decision tree can be adjusted according to the new attack event, so as to correspondingly output the attack or non-attack rule. Therefore, the rules for intrusion detection can be updated in real-time without relearning all of the samples, so that a capability for intrusion detection is improved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating an intrusion detecting system according to an embodiment of the invention.

FIG. 2A is a schematic diagram illustrating a decision tree stored in a decision tree module of FIG. 1.

FIG. 2B is a schematic diagram illustrating an adjusted decision tree of FIG. 2A.

FIG. 3 is a flowchart illustrating a method for establishing classifying rules of the intrusion detecting system of FIG. 1.

FIG. 4 is a schematic diagram illustrating an intrusion detecting system according to an embodiment of the invention.

FIG. 5 is a flowchart illustrating a method for establishing classifying rules of the intrusion detecting system of FIG. 4.

FIG. 6 is a detailed flowchart of a step of providing a decision tree of FIG. 5.

FIG. 7 illustrates a decision tree clustered according to a significant attribute list.

FIG. 8 is a flowchart of a detecting stage of the intrusion detecting system of FIG. 4.

### DETAILED DESCRIPTION OF DISCLOSED EMBODIMENTS

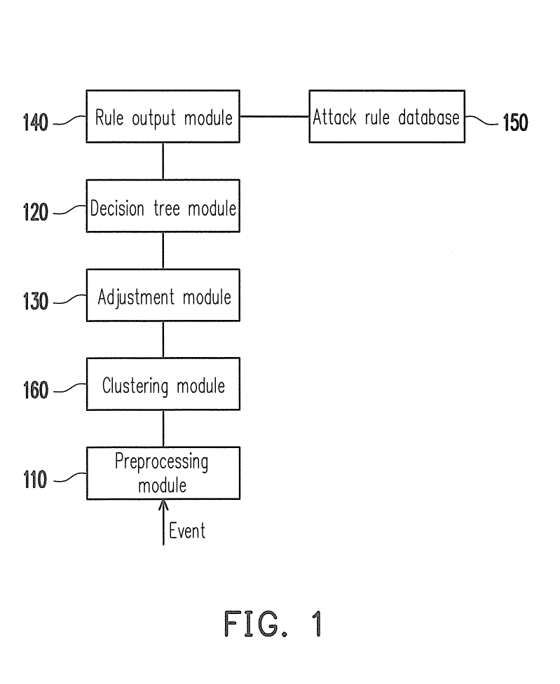

FIG. 1 is a schematic diagram illustrating an intrusion detecting system according to an embodiment of the invention. Referring to FIG. 1, the intrusion detecting system 100 including a preprocessing module 110, a clustering module 160, a decision tree module 120, an adjustment module 130, a rule output module 140 and an attack rule database 150. The preprocessing module 110 is used for receiving a plurality of attribute data of at least one new attack event. The attribute data includes network information of connection staying time, transmission control protocol/user datagram protocol (TCP/UDP) service, packet size, etc.

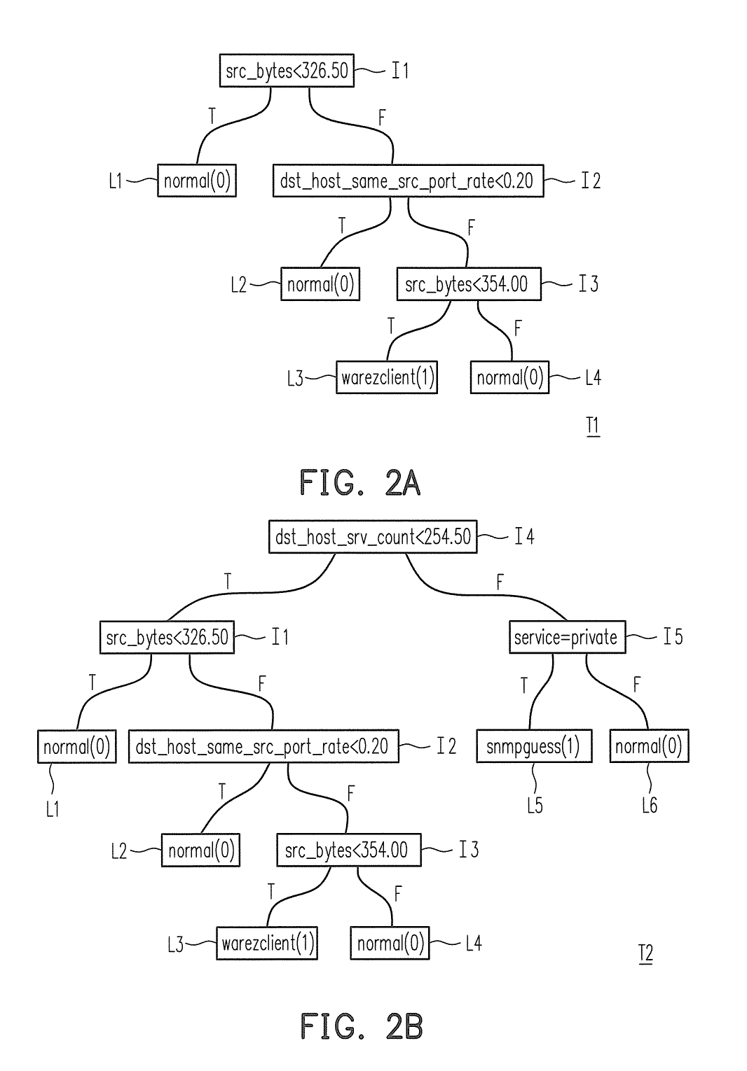

FIG. 2A is a schematic diagram illustrating a decision tree stored in a decision tree module of FIG. 1. Referring to FIG. 2A, the decision tree module 120 is used for storing at least one decision tree T1. Internal nodes I1-I3 of the decision tree T1 respectively represent an attribute judgment condition, and leaf nodes L1-L4 of the decision tree T1 respectively represent an attack event or a non-attack event. For example, the internal node I1 represents judging whether data sent by a source is smaller than 326.50 bytes, the leaf node L1 represents the non-attack event (represented by 0), and the leaf node L3 represents a warezclient attack event (represented by 1). The clustering module 160 is used for clustering similar attribute data in a same group, and finds the decision tree T1 corresponding to the new attack event from the decision tree module 120 according to a clustering algorithm.

FIG. 2B is a schematic diagram illustrating the adjusted decision tree of FIG. 2A. Referring to FIG. 2A and FIG. 2B, the adjustment module 130 is used for adjusting a tree structure (represented by a decision tree T2) of the decision tree T1 corresponding to the new attack event according to the attribute data. As shown in FIG. 2B, compared to the decision tree T1, the decision tree T2 further includes internal nodes 14 and IS and leaf nodes L5 and L6. The rule output module 140 is used for outputting at least one attack rule or at least one non-attack rule according to the adjusted decision tree T2. Taking one of the attack rules as an example, when the event complies with (dst_host_sry_count>254.50) and (service=private), it represents a snmpguess attack event (represented by 1). The attack rule database 150 is used for storing the attack rule or the non-attack rule.

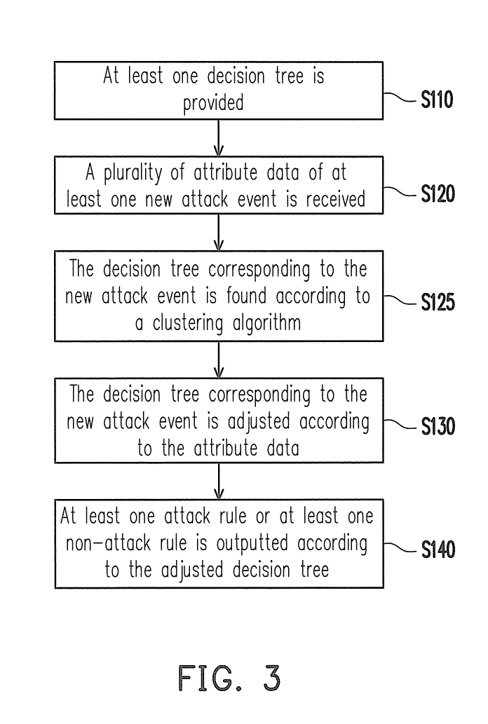

FIG. 3 is a flowchart illustrating a method for establishing classifying rules of the intrusion detecting system of FIG. 1. Referring to FIG. 1 and FIG. 3, operations of the intrusion detecting system 100 roughly include following steps. First, in step S110, at least one decision tree T1 (shown in FIG. 2A) is provided. Then, in step S120, a plurality of attribute data of at least one new attack event is received. Then, in step S125, the decision tree T1 corresponding to the new attack event is found according to the clustering algorithm. Then, in step S130, a tree structure (represented by the decision tree T2 of FIG. 2B) of the decision tree T1 corresponding to the new attack event is adjusted according to the attribute data. Then, in step S140, at least one attack rule or at least one non-attack rule is outputted according to the adjusted decision tree T2. Namely, the rules are generated according to the paths formed by branches T and F, the internal nodes 11-15 and the leaf nodes L1-L6 of the decision tree T2.

It should be noticed that when a new type of attack event is discovered, as long as the decision tree is adjusted according to the new type of attack event, the classifying rules can be updated in real-time online without relearning all of training samples offline.

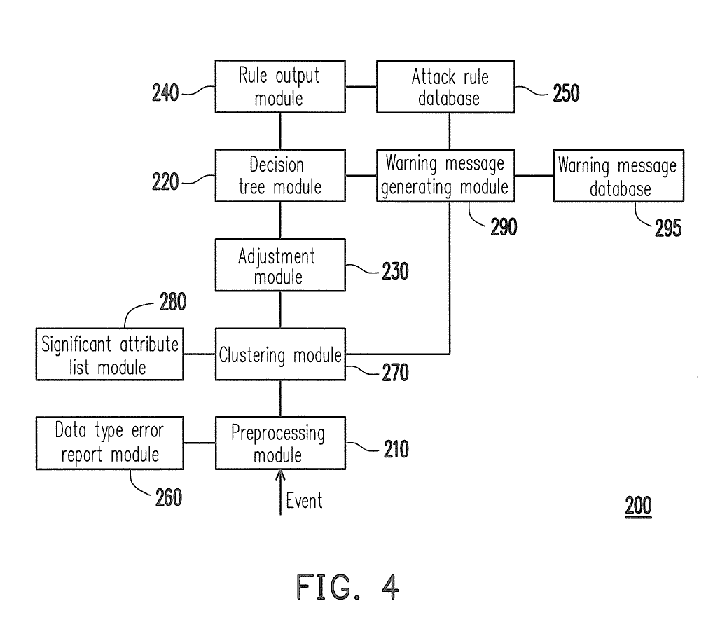

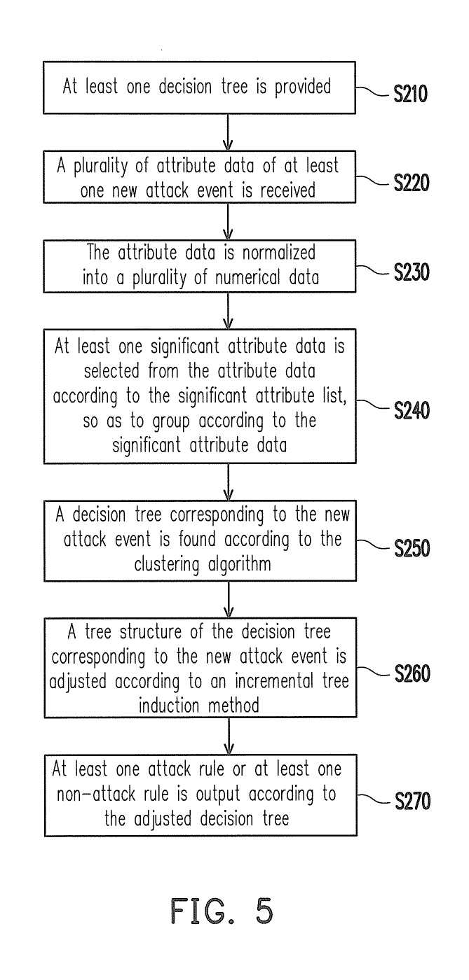

FIG. 4 is a schematic diagram illustrating an intrusion detecting system according to an embodiment of the invention, and FIG. 5 is a flowchart illustrating a method for establishing classifying rules of the intrusion detecting system of FIG. 4. The intrusion detecting system 200 of FIG. 4 and the method of FIG. 5 are described below, and similar devices and steps are not repeated.

Referring to FIG. 4, compared to the intrusion detecting system 100, the intrusion detecting system 200 further includes a data type error report module 260, a clustering module 270, a significant attribute list module 280, a warning message generating module 290 and a warning message database 295. The data type error report module 260 generates a data type error report when a preprocessing module 210 receives attribute data of a wrong type. The clustering module 270 is used for finding the decision tree corresponding to the new attack event according to a clustering algorithm. In the present embodiment, the clustering algorithm is, for example, a K-means or SOM clustering method. The significant attribute list module 280 is used for storing a significant attribute list. In the present embodiment, the significant attribute list may define some significant attributes according to characteristics of a KDD'99 data set. The warning message generating module 290 is used for sending a warning message according to an attack rule database 250 when being under attack. The warning message database 295 is used for storing the warning message.

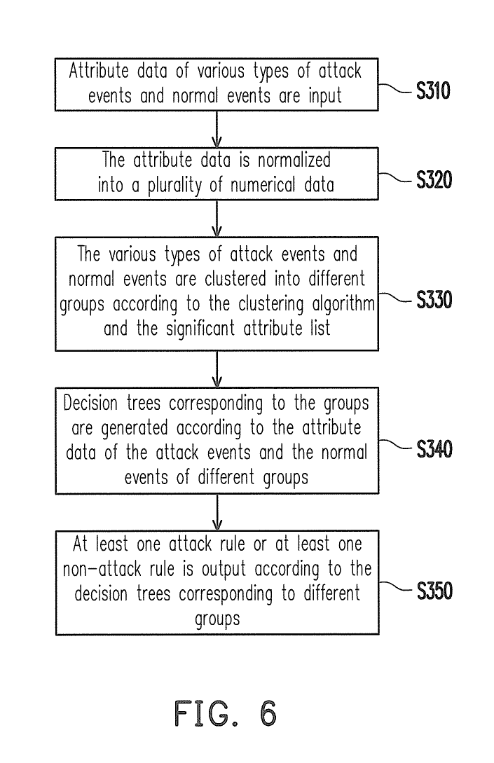

Referring to FIG. 4 and FIG. 5, in step S210, at least one decision tree is provided (which is described in detail later with reference of FIG. 6). Then, in step S220, the preprocessing module 210 receives a plurality of attribute data of at least one new attack event. Then, in step S230, the preprocessing module 210 normalizes the attribute data into a plurality of numerical data. For example, the preprocessing module 210 converts symbol data into numerical data according to a predefined mapping table, and normalizes the numerical data in to values between 0 and 1. In the present embodiment, if the preprocessing module 210 cannot convert the input data into the numerical data or a format error is occurred, the data type error report module 260 can send an error report to a system manager.

Then, in step S240, the clustering module 270 selects at least one significant attribute data from the attribute data according to the significant attribute list, so as to execute the clustering algorithm according to the significant attribute data for grouping. Namely, the attack events or the normal events of similar services or the same service (for example, a HTTP service) are grouped into a same group. In the present embodiment, significant attributes of known attacks can be artificially defined in the significant attribute list. In the significant attribute list, 0 represents an insignificant attribute, and the clustering module 270 neglects the insignificant attribute without processing; 1 represents a significant attribute, and the clustering 270 processes the significant attribute, and calculates a distance of each event attribute, so as to cluster the events of similar distance into the same group.

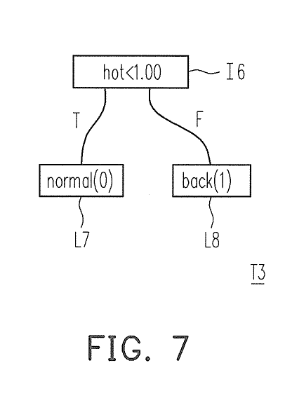

FIG. 7 illustrates a decision tree clustered according to the significant attribute list. As shown in FIG. 7, the decision tree T3 includes an internal node 16 and two leaf nodes L7 and L8. Since an attribute “hot” is enough to distinguish an attack event (back) and a normal event (normal), the attribute “hot” is artificially defined in the significant attribute list as 1, and other attributes are defined as 0. In this case, the clustering module 270 only calculates the attribute “hot” and neglects the other attributes. In this way, the events can be grouped into two groups, wherein one group includes the normal events, and another group includes the attack events.

Then, in step S250, the clustering module 270 finds a decision tree corresponding to the new attack event according to the clustering algorithm. Then, in step S260, an adjustment module 230 adjusts a tree structure of the decision tree corresponding to the new attack event according to an incremental tree induction method. In another embodiment that is not illustrated, the tree structure of the decision tree can also be adjusted according to a concept of a height balanced binary search tree (AVL-tree). Then, in step S270, a rule output module 240 outputs at least one attack rule or at least one non-attack rule to the attack rule database 250 according to the adjusted decision tree.

FIG. 6 is a detailed flowchart of the step of providing the decision tree of FIG. 5. Referring to FIG. 6, in the present embodiment, the decision tree can be established by batch learning a plurality of training events, wherein the training events may include a plurality of attack events and a plurality of normal events. In detail, in step S310, the preprocessing module 210 receives attribute data of various types of attack events and normal events. Then, in step S320, the preprocessing module 210 normalizes the attribute data into a plurality of numerical data. Then, in step S330, the clustering module 270 clusters the various types of attack events and normal events into different groups according to the clustering algorithm and the significant attribute list. In detail, two following processing methods can be performed, and according to a first processing method, the clustering module 270 receives the normalized numerical data output by the preprocessing module 210, and calculates a distance (for example, an Euclidean distance) of each attribute value according to the significant attribute list of the significant attribute list module 280, and calculates a similarity of the distance of each attribute value, and then outputs a grouping result of each attribute value. According to a second processing method, the clustering module 270 performs grouping according to different services, and outputs a grouping result of each attribute value.

Then, in step S340, the adjustment module 230 generates decision trees corresponding to the groups according to the attribute data of the attack events and the normal events of different groups. Then, in step S350, the rule output module 240 outputs at least one attack rule or at least one non-attack rule to the attack rule database 250 according to the decision trees corresponding to different groups.

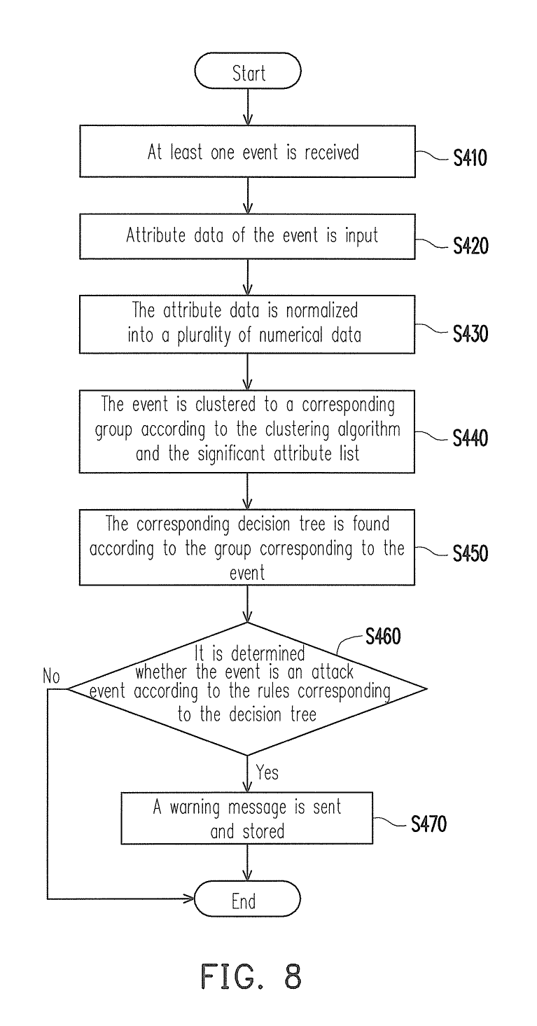

FIG. 8 is a flowchart of a detecting stage of the intrusion detecting system of FIG. 4. Referring to FIG. 8, after the batch learning stage (steps S310-S350) and the progressive learning stage (steps S210-S270), the intrusion detecting system can be used to detect network events. First, in step S410, the preprocessing module 210 receives at least one event. Then, in step S420, attribute data of the event is input to the preprocessing module 210. Then, in step S430, the preprocessing module 210 normalizes the attribute data into a plurality of numerical data. Then, in step S440, the clustering module 270 clusters the event to a corresponding group according to the clustering algorithm and the significant attribute list. Thereafter, in step S450, the warning message generating module 290 finds the corresponding decision tree according to the group corresponding to the event. Then, in step S460, the warning message generating module 290 determines whether the event is an attack event according to the rules corresponding to the decision tree. If the warning message generating module 290 determines that the event is the attack event, a step S470 is executed, by which a warning message is sent and stored to the warning message database 295.

In summary, in the invention, the clustering method is first used to cluster the similar events in a same group, and then the decision tree is updated according to the new attack event. In this way, relearning of the whole system is unnecessary even if more severe attacks such as user to root attacks and remote to local attacks are appeared.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for establishing classifying rules of an intrusion detecting system, comprising:
providing at least one decision tree, wherein internal nodes of the decision tree respectively represent an attribute judgment condition, and leaf nodes of the decision tree respectively represent an attack event or a non-attack event;
receiving a plurality of attribute data of at least one new attack event;
finding the decision tree corresponding to the new attack event according to a clustering algorithm;
adjusting a tree structure of the decision tree corresponding to the new attack event according to the attribute data; and
outputting at least one attack rule or at least one non-attack rule according to the adjusted decision tree.

2. The method for establishing classifying rules of the intrusion detecting system as claimed in claim 1, wherein the step of adjusting the tree structure of the decision tree comprises:
adjusting the tree structure of the decision tree according to an incremental tree induction method.

3. The method for establishing classifying rules of the intrusion detecting system as claimed in claim 1, wherein before the step of adjusting the tree structure of the decision tree, the method further comprises:
normalizing the attribute data into a plurality of numerical data, wherein the numerical data are greater than or equal to 0 and are smaller than or equal to 1.

4. The method for establishing classifying rules of the intrusion detecting system as claimed in claim 1, wherein before the step of adjusting the tree structure of the decision tree, the method further comprises:
selecting at least one significant attribute data from the attribute data according to a significant attribute list, so as to execute the clustering algorithm according to the significant attribute data.

5. The method for establishing classifying rules of the intrusion detecting system as claimed in claim 1, wherein the step of providing the decision tree comprises:
batch learning a plurality of training events to establish the decision tree.

6. An intrusion detecting system, comprising:
a decision tree module, for storing at least one decision tree, wherein internal nodes of the decision tree respectively represent an attribute judgment condition, and leaf nodes of the decision tree respectively represent an attack event or a non-attack event;
a preprocessing module, for receiving a plurality of attribute data of at least one new attack event;
a clustering module, for finding the decision tree corresponding to the new attack event according to a clustering algorithm;
an adjustment module, for adjusting a tree structure of the decision tree corresponding to the new attack event according to the attribute data;
a rule output module, for outputting at least one attack rule or at least one non-attack rule according to the adjusted decision tree; and
an attack rule database, for storing the attack rule or the non-attack rule.

7. The intrusion detecting system as claimed in claim 6, further comprising:
a significant attribute list module, for storing a significant attribute list, wherein the clustering module selects at least one significant attribute data from the attribute data according to the significant attribute list, so as to execute the clustering algorithm according to the significant attribute data.

8. The intrusion detecting system as claimed in claim 6, wherein the preprocessing module further normalizes the attribute data into a plurality of numerical data, wherein the numerical data are greater than or equal to 0 and are smaller than or equal to 1.

9. The intrusion detecting system as claimed in claim 6, further comprising:
a warning message generating module, for generating a warning message according to the attack rule database when being under attack; and
a warning message database, for storing the warning message.
